(19) United States
(12) Patent Application Publication
(10) Pub. No.: US 2020/0299467 A1
(43) Pub. Date: Sep. 24, 2020

(54) FLUOROELASTOMER COMPOSITION

(71) Applicant: SOLVAY SPECIALTY POLYMERS ITALY S.P.A.

(72) Inventors: Matteo FANTONI, Vanzaghello (IT); Liubov CHERNYSHEVA, Milano (IT); Tiziana TACCONE, Pogliano Milanese (IT); Fiorenza D'APRILE, Milanese (IT)

(21) Appl. No.: 16/088,060

(22) PCT Filed: Mar. 21, 2017
(86) PCT No.: PCT/EP2017/056673

§ 371 Date: Sep. 24, 2018

(30) Foreign Application Priority Data
Mar. 24, 2016 (EP) 16162365.7

(51) Int. Cl. C08J 3/16; C08J 3/26; C08K 3/34; C08L 27/24

(52) U.S. Cl. CPC C08J 3/16; C08J 3/26; C08K 3/34; C08L 27/24; C08K 2201/011; C08J 2327/18; C08J 2319/02; C08K 2201/005; C08J 2315/02

(57) ABSTRACT

The present invention pertains to a fluoroelastomer composition including well-dispersed carbide fillers, to a method for its manufacture comprising: (i) providing an aqueous dispersion of particles of at least one non-metal carbide possessing an average particle size of less than 100 nm; (ii) providing an aqueous latex of a fluoroelastomer; (iii) mixing the said dispersion and the said latex; and (iv) coagulating, and to the use of the same for manufacturing cured articles.

### CROSS-REFERENCE TO RELATED APPLICATION

This application claims priority to European application No. 16162365.7 filed on Mar. 24, 2016, the whole content of this application being incorporated herein by reference for all purposes.

### TECHNICAL FIELD

The present invention pertains to a fluoroelastomer composition including well-dispersed carbide fillers, to a method for its manufacture, and to the use of the same for manufacturing cured articles.

### BACKGROUND ART

Vulcanized (per)fluoroelastomers are materials with excellent heat-resistance and chemical-resistance characteristics, which are generally used in the manufacture of technical articles such as sealing parts, pipes, oil seals and O-rings in which the leaktightness, the mechanical properties and the resistance to substances such as mineral oils, hydraulic fluids, solvents or chemical agents of diverse nature must be ensured over a wide range of working temperatures, from high to very low temperatures.

Generally, reinforcing fillers are incorporated in fluoroelastomer compounds for improving mechanical properties and hardness.

For certain advances applications, in particular in the domain of semiconductors' manufacture, the requirements for improved mechanical properties are coupled with requirements for the filler to resist harsh conditions, e.g. repeated plasma exposures, and extremely severe purity requirements, including substantial absence of free and/or leachable metal compounds. All these requirements substantially restrict the scope of usable reinforcing materials which could be employed in these conditions.

On the other side, fluoroelastomer compounds comprising carbide compounds, and more specifically silicon carbide are known in the art.

Notably, ZHIJUN, SHUAI, et al. Preparation and mechanical properties of micro- and nano-sized SiC/fluoroelastomer composites. Journal of Wuhan University of Technology-Mater. Sci. Ed. August 2013, vol. 28, no. 4, p. 658-663. Disclose micro- and nano-sized SiC/fluoroelastomer (FKM) composites which were prepared by a mechanical mixing method. The tensile properties of composite increased with the increasing of micro- and nano-sized SiC content up to about 20 phr, these performances being mainly attributed to the dispersed micro- and nano-sized SiC particles characterized by SEM images.

Similarly, U.S. Pat. No. 7,214,423 discloses certain compositions comprising a fluoropolymer, at least one filler, and, alone or in combination, a titanate, zirconate, or aluminate coupling agent. The filler is chosen for its hardness and thermal conductivity (conductivity should be several times greater than the base elastomer) with Al₂O₃, CuO, ZnO, SiC or aluminum nitride being exemplary embodiments.

Further, a silicon carbide material supplier's website (http://www.nanomakers.co/#!elastomeres/c24g7, as accessed in March 2016) explains that outstanding features of temperature resistance and extensive chemical compatibility of perfluorinated elastomers and fluoroelastomers can be improved by the addition of nano SiC fillers, mentioning the use of a specific material (SiC NM 99) for elastomers in seals for semiconductors.

Nevertheless, carbide compounds, such as SiC, are difficult to incorporate into a fluoroelastomer matric by mere mechanical techniques, because of inherent apolar properties of the (per)fluoroelastomer matrix. On the other side, it is well known that contribution to the improvement of mechanical performances of the fluoroelastomer can be optimized by achieving optimal distribution of the filler therein used.

Further, in addition, the said carbides are highly abrasive compounds, so that their incorporation into fluoroelastomer curable compounds through usual techniques is such to substantially submit to wear all metallic components which are used to transfer shear energy for effecting mixing. As a consequence, metal contamination arises, which hence renders compounds so obtained unsuitable for use in semiconductors' applications.

On the other side, US 2012029152 (DAIKIN) 2 Feb. 2012 discloses notably a method for producing a fluoroelastomer mixture of two different fluoroelastomers, comprising the step of co-coagulation of aqueous dispersion containing the latters. The composition so obtained may contain may contain a common filler, including notably metal carbide fillers, such as silicon carbide and aluminium carbide; metal nitride fillers, such as silicon nitride and aluminium nitride; and inorganic fillers, such as aluminium fluoride, carbon fluoride, barium sulfate, carbon black, silica, clay, and talc.

### SUMMARY OF INVENTION

The Applicant has now found an improved method for the manufacture of fluoroelastomer compositions comprising non-metal carbide compounds which are such to avoid any metal contamination while providing outstanding dispersions of the filler, and to fluoroelastomers compounds obtained therefrom, which, thanks to the excellent dispersion of the filler are endowed with outstanding mechanical and sealing properties.

Hence, in a first aspect, the invention pertains to a method for manufacturing a fluoroelastomer composition [composition (C)], said method comprising:

(i) providing an aqueous dispersion [dispersion (S)] of particles of at least one non-metal carbide possessing an average particle size of less than 100 nm [carbide (S)];
(ii) providing an aqueous latex [latex (L)] of at least one (per)fluoroelastomer [fluoroelastomer (A)];
(iii) mixing the dispersion (S) and the latex (L) in such amounts so as to obtain an aqueous mixture [mixture (M)] comprising from 1 to 50 weight parts of carbide (S), per 100 parts of fluoroelastomer (A); and
(iv) coagulating the mixture (M), so as to recover the composition (C).

Further, the invention pertains to a fluoroelastomer composition [composition (C)], comprising at least one fluoroelastomer (A) and at least one carbide (S) in an amount of 1 to 50 weight parts per hundred parts of fluoroelastomer (A), wherein the said carbide (S) is dispersed in the fluoroelastomer (A) in a manner such that agglomerates of particles of carbide (S) having a size exceeding 100 nm are substantially absent.

### BRIEF DESCRIPTION OF DRAWINGS

FIG. 1 is a SEM picture at a magnification of 50×, taken on a sample of the fluoroelastomer composition of example 1.

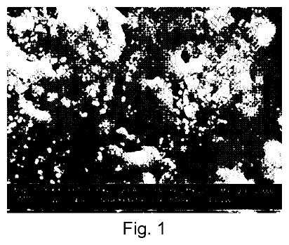

### DESCRIPTION OF EMBODIMENTS

As said, the method of the invention comprises providing an aqueous dispersion (S), as above detailed, i.e. a dispersion of particles of carbide (S) in a liquid dispersing medium comprising water.

The said liquid dispersing medium may additionally comprise one or more than one additional solvents, which are generally selected among water-soluble organic solvents.

Typically, the said liquid dispersing medium may additionally comprise at least one hydroxyl-containing organic solvent, notably selected from the group consisting of aliphatic mono- and poly-hydric alcohols.

Non-limitative examples thereof are notably methanol, ethanol, isopropanol, butanols, ethylene glycol, mono-ethers of ethylene glycol, mono-esters of ethylene glycol, glycerol, and the like.

Particularly good results have been obtained when the dispersion (S) comprised ethylene glycol and ethanol.

The amount of the said additional solvent is not particularly limited, but it is generally understood that the dispersion (S) will comprise at least 30% wt, preferably at least 40% wt, more preferably at least 50% wt of additional solvent, with respect to the total weight of the dispersion (S). Further, the dispersion (S) generally comprises at most 85% wt, preferably at most 80% wt of additional solvent, with respect to the total weight of the dispersion (S).

The dispersion (S) comprises particles of at least one carbide (S). Carbides (S) which have been found particularly useful within the frame of the present invention are notably silicon carbide (SiC) and boron carbide (BC), with SiC being preferred.

The particles of carbide (S) possess an average particle size of less than 100 nm, preferably of less than 80 nm, more preferably of less than 60 nm and/or an average particle size of at least 1 nm, preferably at least 5 nm, more preferably at least 10 nm.

The average particle size of the carbide (S) is determined by laser light scattering technique, according to ISO 22412 Standard.

Generally, the method of the invention comprises an additional step of manufacturing the dispersion (S), said step comprising mixing particles of carbide (S) in a liquid dispersing medium comprising water, and optionally the said additional solvent.

Mixing can be effected in standard devices; vessels equipped with axial-flow impellers or radial-flow impellers, including multi-stage impellers, can be used, and vessel may be equipped with baffles, which converts some of the rotational motion into vertical motion.

Mixing time and temperatures are not particularly critical; generally, mixing at temperatures of 20 to 60° C. is effective for providing dispersion (S). As said above, according to certain preferred embodiment's the method includes adding one or more than one additional solvent, as above detailed, in the amounts specified above, which may enable improving dispersing-ability of the particles of carbide (S) in the aqueous liquid dispersing medium.

The dispersion (S) comprises at least 0.5% wt, preferably at least 1% wt, more preferably at least 2% wt of carbide (S), with respect to the total weight of the dispersion (S). Further, the dispersion (S) generally comprises at most 10% wt, preferably at most 9% wt, more preferably at most 8% wt of carbide (S), with respect to the total weight of the dispersion (S).

The method of the invention further comprises providing an aqueous latex of fluoroelastomer (A).

The expression “aqueous latex” is to be understood according to its usual meaning, i.e. to designate a dispersion of polymer particles in an aqueous medium.

Latex of fluoroelastomers (A) can be manufactured via known emulsion-polymerization techniques. Suitable techniques include surfactant-assisted emulsion polymerization, in particular in the presence of fluorinated surfactant, and including micro-emulsion polymerization, in a fluorinated dispersed phase stabilized with appropriate surfactant, in particular in micro-droplets of a fluorinated perfluoropolyether oil stabilized with fluorinated surfactant, e.g. perfluoropolyether carboxylate salts.

Aqueous medium is predominantly composed of water, although it may comprise minor amount of other components, including e.g. residues of initiators, (fluoro)surfactants, and/or other auxiliaries which may derive from the manufacture of the latex (L) itself, in an amount of generally less than 5% wt., with respect to the total weight of the latex (L).

Generally, the latex (L) comprises the fluoropolymer (A) in an amount of at least 15% wt., preferably at least 20% wt., more preferably at least 25% wt., and/or in an amount of at most 60% wt., preferably at most 50% wt., more preferably at most 40% wt., with respect to the total weight of latex (L).

For the purposes of this invention, the term “(per)fluoroelastomer” [fluoroelastomer (A)] is intended to designate a fluoropolymer resin serving as a base constituent for obtaining a true elastomer, said fluoropolymer resin comprising more than 10% wt, preferably more than 30% wt, of recurring units derived from at least one ethylenically unsaturated monomer comprising at least one fluorine atom (hereafter, (per)fluorinated monomer) and, optionally, recurring units derived from at least one ethylenically unsaturated monomer free from fluorine atom (hereafter, hydrogenated monomer).

True elastomers are defined by the ASTM, Special Technical Bulletin, No. 184 standard as materials capable of being stretched, at room temperature, to twice their intrinsic length and which, once they have been released after holding them under tension for 5 minutes, return to within 10% of their initial length in the same time.

Non limitative examples of suitable (per)fluorinated monomers are notably:
C₂-C₈ fluoro- and/or perfluoroolefins, such as tetrafluoroethylene (TFE), hexafluoropropene (HFP), pentafluoropropylene, and hexafluoroisobutylene;
C₂-C₈ hydrogenated monofluoroolefins, such as vinyl fluoride; 1,2-difluoroethylene, vinylidene fluoride (VDF) and trifluoroethylene (TrFE);
(per)fluoroalkylethylenes complying with formula CH₂═CH—R_{f0}, in which R_{f0} is a C₁-C₆ (per)fluoroalkyl or a C₁-C₆ (per)fluorooxyalkyl having one or more ether groups;
chloro- and/or bromo- and/or iodo-C₂-C₆ fluoroolefins, like chlorotrifluoroethylene (CTFE);
fluoroalkylvinylethers complying with formula CF₂═CFOR_{f1} in which R_{f1} is a C₁-C₆ fluoro- or perfluoroalkyl, e.g. —CF₃, —C₂F₅, —C₃F₇;
hydrofluoroalkylvinylethers complying with formula CH₂═CFOR_{f1} in which R_{f1} is a C₁-C₆ fluoro- or perfluoroalkyl, e.g. —CF₃, —C₂F₅, —C₃F₇;
fluoro-oxyalkylvinylethers complying with formula CF₂═CFOX₀, in which X₀ is a C₁-C₁₂ oxyalkyl, or a C₁-C₁₂ (per)fluorooxyalkyl having one or more ether groups; in particular (per)fluoro-methoxy-vinylethers complying with formula CF₂═CFOCF₂OR_{f2} in which R_{f2} is a C₁-C₆ fluoro- or perfluoroalkyl, e.g. —CF₃, —C₂F₅, —C₃F₇ or a C₁-C₆ (per)fluorooxyalkyl having one or more ether groups, like —C₂F₅—O—CF₃;
functional fluoro-alkylvinylethers complying with formula CF₂═CFOY₀, in which Y₀ is a C₁-C₁₂ alkyl or (per)fluoroalkyl, or a C₁-C₁₂ oxyalkyl or a C₁-C₁₂ (per)fluorooxyalkyl, said Y₀ group comprising a carboxylic or sulfonic acid group, in its acid, acid halide or salt form;
(per)fluorodioxoles, of formula:

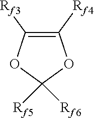

wherein each of R_{f3}, R_{f4}, R_{f5}, R_{f6}, equal to or different from each other, is independently a fluorine atom, a C₁-C₆ fluoro- or per(halo)fluoroalkyl, optionally comprising one or more oxygen atom, e.g. —CF₃, —C₂F₅, —C₃F₇, —OCF₃, —OCF₂CF₂OCF₃.

Examples of hydrogenated monomers are notably hydrogenated alpha-olefins, including ethylene, propylene, 1-butene, diene monomers, styrene monomers, alpha-olefins being typically used.

Fluoroelastomers (A) are in general amorphous products or products having a low degree of crystallinity (crystalline phase less than 20% by volume) and a glass transition temperature (T_{g}) below room temperature. In most cases, the fluoroelastomer (A) has advantageously a T_{g} below 10° C., preferably below 5° C., more preferably 0° C.

The fluoroelastomer (A) is preferably selected among:

(1) VDF-based copolymers, in which VDF is copolymerized with at least one comonomer selected from the group consisting of:
(a) C₂-C₈ perfluoroolefins, such as tetrafluoroethylene (TFE), hexafluoropropylene (HFP);
(b) hydrogen-containing C₂-C₈ olefins, such as vinyl fluoride (VF), trifluoroethylene (TrFE), hexafluoroisobutene (HFIB), perfluoroalkyl ethylenes of formula CH₂═CH—R_{f}, wherein R_{f} is a C₁-C₆ perfluoroalkyl group;
(c) C₂-C₈ fluoroolefins comprising at least one of iodine, chlorine and bromine, such as chlorotrifluoroethylene (CTFE);
(d) (per)fluoroalkylvinylethers (PAVE) of formula CF₂═CFOR_{f}, wherein R_{f} is a C₁-C₆ (per)fluoroalkyl group, preferably CF₃, C₂F₅, C₃F₇; (e) (per)fluoro-oxy-alkylvinylethers of formula CF₂═CFOX, wherein X is a C₁-C₁₂ ((per)fluoro)-oxyalkyl comprising catenary oxygen atoms, e.g. the perfluoro-2-propoxypropyl group;
(f) (per)fluorodioxoles having formula:

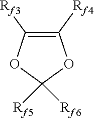

wherein each of R_{f3}, R_{f4}, R_{f5}, R_{f6}, equal to or different from each other, is independently selected from the group consisting of fluorine atom and C₁-C₆ (per)fluoroalkyl groups, optionally comprising one or more than one oxygen atom, such as notably —CF₃, —C₂F₅, —C₃F₇, —OCF₃, —OCF₂CF₂OCF₃; preferably, perfluorodioxoles;
(g) (per)fluoro-methoxy-vinylethers (MOVE, hereinafter) having formula:

CF₂═CFOCF₂OR_{f2}

wherein R_{f2} is selected from the group consisting of C₁-C₆ (per)fluoroalkyls; C₅-C₆ cyclic (per)fluoroalkyls; and C₂-C₆ (per)fluorooxyalkyls, comprising at least one catenary oxygen atom; R_{f2} is preferably —CF₂CF₃ (MOVE1); —CF₂CF₂OCF₃ (MOVE2); or —CF₃ (MOVE3);
(h) C₂-C₈ non-fluorinated olefins (Ol), for example ethylene and propylene;
(i) ethylenically unsaturated compounds comprising nitrile (—CN) groups, possibly (per)fluorinated; and
(2) TFE-based copolymers, in which TFE is copolymerized with at least one comonomer selected from the group consisting of (c), (d), (e), (g), (h) and (i) as above detailed.

Optionally, fluoroelastomer (A) of the present invention also comprises recurring units derived from a bis-olefin [bis-olefin (OF)] having general formula:

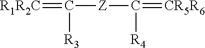

wherein R₁, R₂, R₃, R₄, R₅ and R₆, equal or different from each other, are H or C₁-C₅ alkyl; Z is a linear or branched C₁-C₁₈ hydrocarbon radical (including alkylene or cycloalkylene radical), optionally containing oxygen atoms, preferably at least partially fluorinated, or a (per)fluoropolyoxyalkylene radical, e.g. as described in EP 661304 A (AUSIMONT SPA) 5 Jul. 1995.

The bis-olefin (OF) is preferably selected from the group consisting of those complying with formulae (OF-1), (OF-2) and (OF-3):

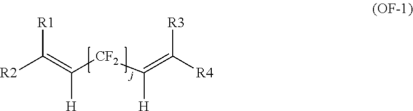

wherein j is an integer between 2 and 10, preferably between 4 and 8, and R1, R2, R3, R4, equal or different from each other, are H, F or C₁₋₅ alkyl or (per)fluoroalkyl group;

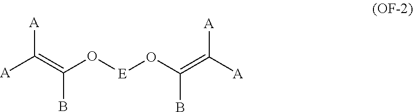

wherein each of A, equal or different from each other and at each occurrence, is independently selected from F, Cl, and H; each of B, equal or different from each other and at each occurrence, is independently selected from F, Cl, H and OR_{B}, wherein R_{B} is a branched or straight chain alkyl radical which can be partially, substantially or completely fluorinated or chlorinated; E is a divalent group having 2 to 10 carbon atom, optionally fluorinated, which may be inserted with ether linkages; preferably E is a —(CF₂)ₘ— group, with m being an integer from 3 to 5; a preferred bis-olefin of (OF-2) type is F₂C═CF—O—(CF₂)₅—O—CF═CF₂.

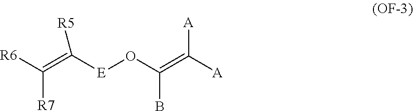

wherein E, A and B have the same meaning as above defined; R5, R6, R7, equal or different from each other, are H, F or C₁₋₅ alkyl or (per)fluoroalkyl group.

Exemplary fluoroelastomers (A) which can be used in the composition of the present invention are those having following monomers composition (in mol %, with respect to the total moles of recurring units):

(i) vinylidene fluoride (VDF) 35-85%, hexafluoropropene (HFP) 10-45%, tetrafluoroethylene (TFE) 0-30%, (per)fluoroalkylvinylethers (PAVE) 0-15%; bis-olefin (OF): 0-5%;
(ii) vinylidene fluoride (VDF) 50-80%, (per)fluoroalkylvinylethers (PAVE) 5-50%, tetrafluoroethylene (TFE) 0-20%, bis-olefin (OF): 0-5%;
(iii) vinylidene fluoride (VDF) 20-30%, C₂-C₈ non-fluorinated olefins (Ol) 10-30%, hexafluoropropene (HFP) and/or (per)fluoroalkylvinylethers (PAVE) 18-27%, tetrafluoroethylene (TFE) 10-30%; bis-olefin (OF): 0-5%;
(iv) tetrafluoroethylene (TFE) 50-80%, (per)fluoroalkylvinylethers (PAVE) 15-50%; bis-olefin (OF): 0-5%;
(v) tetrafluoroethylene (TFE) 45-65%, C₂-C₈ non-fluorinated olefins (Ol) 20-55%, vinylidene fluoride 0-30%; bis-olefin (OF): 0-5%;
(vi) tetrafluoroethylene (TFE) 32-60% mol %, C₂-C₈ non-fluorinated olefins (Ol) 10-40%, (per)fluoroalkylvinylethers (PAVE) 20-40%, fluorovinyl ethers (MOVE) 0-30%; bis-olefin (OF): 0-5%;
(vii) tetrafluoroethylene (TFE) 33-75%, (per)fluoroalkylvinylethers (PAVE) 15-45%, vinylidene fluoride (VDF) 5-30%, hexafluoropropene HFP 0-30%; bis-olefin (OF): 0-5%;
(viii) vinylidene fluoride (VDF) 35-85%, (per)fluoro-methoxy-vinylethers (MOVE) 5-40%, (per)fluoroalkylvinylethers (PAVE) 0-30%, tetrafluoroethylene (TFE) 0-40%, hexafluoropropene (HFP) 0-30%; bis-olefin (OF): 0-5%;
(ix) tetrafluoroethylene (TFE) 20-70%, (per)fluoro-methoxy-vinylethers (MOVE) 25-75%, (per)fluoroalkylvinylethers (PAVE) 0-50%, bis-olefin (OF): 0-5%.

According to certain embodiments of the invention, the fluoroelastomer (A) may comprise cure sites; the selection of cure sites is not particularly critical, provided that they ensure adequate reactivity in curing conditions.

The fluoroelastomer (A) can comprise said cure sites either as pendant groups bonded to certain recurring units or as end groups of the polymer chain.

Among cure-site containing recurring units, mention can be notably made of:

(CSM-1) iodine or bromine containing monomers of formula:

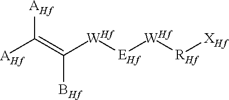

wherein each of A_{Hf}, equal to or different from each other and at each occurrence, is independently selected from F, Cl, and H; B_{Hf} is any of F, Cl, H and OR^{Hf}_{B}, wherein R^{Hf}_{B} is a branched or straight chain alkyl radical which can be partially, substantially or completely fluorinated or chlorinated; each of W^{Hf} equal to or different from each other and at each occurrence, is independently a covalent bond or an oxygen atom; E_{Hf} is a divalent group having 2 to 10 carbon atom, optionally fluorinated; R_{Hf} is a branched or straight chain alkyl radical, which can be partially, substantially or completely fluorinated; and R_{Hf} is a halogen atom selected from the group consisting of Iodine and Bromine; which may be inserted with ether linkages; preferably E is a —(CF₂)ₘ— group, with m being an integer from 3 to 5;
(CSM-2) ethylenically unsaturated compounds comprising nitrile (—CN) groups, possibly (per)fluorinated.

Among cure-site containing monomers of type (CSM1), preferred monomers are those selected from the group consisting of:

(CSM1-A) iodine-containing perfluorovinylethers of formula:

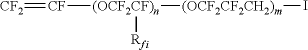

with m being an integer from 0 to 5 and n being an integer from 0 to 3, with the provisio that at least one of m and n is different from 0, and R_{fi} being F or CF₃; (as notably described in U.S. Pat. No. 4,745,165 (AUSIMONT SPA) 17 May 1988, U.S. Pat. No. 4,564,662 (MINNESOTA MINING & MFG [US]) 14 Jan. 1986 and EP 199138 A (DAIKIN IND LTD) 29 Oct. 1986); and (CSM-1B) iodine-containing ethylenically unsaturated compounds of formula:

CX¹X²═CX³—(CF₂CF₂)—I

wherein each of X¹, X² and X³, equal to or different from each other, are independently H or F; and p is an integer from 1 to 5; among these compounds, mention can be made of CH₂═CHCF₂CF₂I, I(CF₂CF₂)₂ CH═CH₂, ICF₂CF₂CF═CH₂, I(CF₂CF₂)₂CF═CH₂;
(CSM-1C) iodine-containing ethylenically unsaturated compounds of formula:

CHR═CH—Z—CH₂CHR—I

wherein R is H or CH₃, Z is a C₁-C₁₈ (per)fluoroalkylene radical, linear or branched, optionally containing one or more ether oxygen atoms, or a (per)fluoropolyoxyalkylene radical; among these compounds, mention can be made of CH₂═CH—(CF₂)₄CH₂CH₂I, CH₂═CH—(CF₂)₆CH₂CH₂I, CH₂ ═CH—(CF₂)₈CH₂CH₂I, CH₂═CH—(CF₂)₂CH₂CH₂I;
(CSM-1D) bromo and/or iodo alpha-olefins containing from 2 to 10 carbon atoms such as bromotrifluoroethylene or bromotetrafluorobutene described, for example, in U.S. Pat. No. 4,035,565 (DU PONT) 12 Jul. 1977 or other compounds bromo and/or iodo alpha-olefins disclosed in U.S. Pat. No. 4,694,045 (DU PONT) 15 Sep. 1987.

Among cure-site containing monomers of type (CSM2), preferred monomers are (per)fluorinated and are especially those selected from the group consisting of:

(CSM2-A) perfluorovinyl ethers containing nitrile groups of formula CF₂ ═CF—(OCF₂CFX^{CN})ₘ—O—(CF₂)ₙ—CN, with X^{CN} being F or CF₃, m being 0, 1, 2, 3 or 4; n being an integer from 1 to 12;
(CSM2-B) perfluorovinyl ethers containing nitrile groups of formula CF₂ ═CF—(OCF₂CFX^{CN})_{m′}—O—CF₂—CF(CF₃)—CN, with X^{CN} being F or CF₃, m′ being 0, 1, 2, 3 or 4.
Specific examples of cure-site containing monomers of type CSM2-A and CSM2-B suitable to the purposes of the present invention are notably those described in U.S. Pat. No. 4,281,092 (DU PONT) 28 Jul. 1981, U.S. Pat. No. 4,281,092 (DU PONT) 28 Jul. 1981, U.S. Pat. No. 5,447,993 (DU PONT) 5 Sep. 1995 and U.S. Pat. No. 5,789,489 (DU PONT) 4 Aug. 1998.

Within the frame of the present invention, preferred fluoroelastomer (A) are fluoroelastomers (A) comprising iodine and/or bromine cure sites. Iodine and/or bromine is generally comprised in the fluoroelastomer (A) in an amount of 0.001 to 10% wt, with respect to the total weight of fluoroelastomer (A). Among these, iodine cure sites are those selected for maximizing curing rate.

According to this embodiment, for ensuring acceptable reactivity it is generally understood that the content of iodine and/or bromine in the fluoroelastomer (A) should be of at least 0.05% wt, preferably of at least 0.1% weight, more preferably of at least 0.15% weight, with respect to the total weight of fluoroelastomer (A).

On the other side, amounts of iodine and/or bromine not exceeding preferably 7% wt, more specifically not exceeding 5% wt, or even not exceeding 4% wt, with respect to the total weight of fluoroelastomer (A), are those generally selected for avoiding side reactions and/or detrimental effects on thermal stability.

These iodine or bromine cure sites of these preferred embodiments of the invention might be comprised as pending groups bound to the backbone of the fluoroelastomer (A) polymer chain or might be comprised as terminal groups of said polymer chain.

According to a first embodiment, the iodine and/or bromine cure sites are comprised as pending groups bound to the backbone of the fluoroelastomer polymer chain; the fluoroelastomer (A) according to this embodiment typically comprises recurring units derived from brominated and/or iodinated cure-site comonomers selected from:
bromo and/or iodo alpha-olefins containing from 2 to 10 carbon atoms such as bromotrifluoroethylene or bromotetrafluorobutene described, for example, in U.S. Pat. No. 4,035,565 (DU PONT) 12 Jul. 1977 or other compounds bromo and/or iodo alpha-olefins disclosed in U.S. Pat. No. 4,694,045 (DU PONT) 15 Sep. 1987;
iodo and/or bromo fluoroalkyl vinyl ethers (as notably described in U.S. Pat. No. 4,745,165 (AUSIMONT SPA) 17 May 1988, U.S. Pat. No. 4,564,662 (MINNESOTA MINING & MFG [US]) 14 Jan. 1986 and EP 199138 A (DAIKIN IND LTD) 29 Oct. 1986).

The fluoroelastomer according to this embodiment generally comprises recurring units derived from brominated and/or iodinated cure-site monomers in amounts of 0.05 to 5 mol per 100 mol of all other recurring units of the fluoroelastomer (A), so as to advantageously ensure above mentioned iodine and/or bromine weight content.

According to a second preferred embodiment, the iodine and/or bromine cure sites (preferably iodine cure sites) are comprised as terminal groups of the fluoroelastomer (A) polymer chain; the fluoroelastomer according to this embodiment is generally obtained by addition to the polymerization medium during fluoroelastomer manufacture of anyone of:
iodinated and/or brominated chain-transfer agent(s); suitable chain-chain transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≤x+y≤2 (see, for example, U.S. Pat. No. 4,243,770 (DAIKIN IND LTD) 6 Jan. 1981 and U.S. Pat. No. 4,943,622 (NIPPON MEKTRON KK) 24 Jul. 1990); and
alkali metal or alkaline-earth metal iodides and/or bromides, such as described notably in U.S. Pat. No. 5,173,553 (AUSIMONT SRL) 22 Dec. 1992.

The method of the invention comprises a step of mixing the dispersion (S) and the latex (L) in such amounts so as to obtain an aqueous mixture [mixture (M)] comprising from 1 to 50 weight parts of carbide (S), per 100 parts of fluoroelastomer (A).

The step of mixing can be carried out in standard devices; agitated vessels, having vertical and/or radial flow impellers and/or possibly equipped with baffles, can be used. In this step, the equipment used is generally selected to produce high volumetric flow, but low shear, so as to avoid any risk of premature coagulation of the fluoroelastomer (A).

Generally, the amounts of latex (L) and dispersion (S) are adjusted so as to obtain a mixture (M) comprising at least 1, preferably at least 3, more preferably at least 5 phr of carbide (S) with respect to fluoroelastomer (A), and/or comprising at most 40, preferably at most 30, more preferably at most 20 phr of carbide (S) with respect to fluoroelastomer (A).

The expression “phr” is used herein according to its usual meaning, i.e. for designating weight parts per hundred weight parts of reference.

Mixing is carried out generally at a temperature of at least 5° C., preferably of at least 15° C., more preferably at least 20° C. and/or at a temperature of at most 80° C., preferably at most 70° C., more preferably at most 60° C., even more preferably at most 50° C.

It is nevertheless generally preferred to accomplish mixing around about room temperature, or generally between 15 and 30° C.

The mixture (M) can be coagulated by standard techniques.

The mixture (M) can be coagulated through addition of an electrolyte or through any electrolyte-free technique.

Among electrolyte-free techniques, mention can be made of coagulation through high pressure compression/decompression, e.g. by forced flow through a series of restrained openings; of coagulation under high shear, e.g. under extremely vigorous stirring; and of coagulation by freeze/taw techniques.

It is nevertheless generally preferred to proceed with coagulating the mixture (M) by addition of an electrolyte. This addition is generally performed under stirring.

The choice of the electrolyte is not particularly limited, and electrolytes such as sulphuric acid, nitric acid, hydrochloridric acid, magnesium nitrate, aluminum sulphate may be used.

This being said, when metal contamination may be an issue, electrolyte will preferably selected from nitric acid and hydrochloridric acid, more preferably nitric acid.

A coagulate is so generated during this coagulation step, whose separation from the dispersing medium may be effected by using conventional techniques such as flotation, filtration, centrifugation, decantation, or a combination of these techniques.

The coagulate so recovered is generally dried using standard techniques, so as to advantageously remove residual moisture.

A composition (C) is hence so recovered.

As said, the invention further pertains to a composition (C) comprising at least one fluoroelastomer (A) and at least one carbide (S) in an amount of 1 to 50 weight parts per hundred parts of fluoroelastomer (A), wherein the said carbide (S) is dispersed in the fluoroelastomer (A) in a manner such that agglomerates of particles of carbide (S) having a size exceeding 100 nm are substantially absent.

The composition (C) of the invention can be manufactured through the method of the invention, as above detailed.

All features described above for the fluoroelastomer (A), and carbide (S) are applicable as relevant embodiment's of the composition (C) of the invention.

The expression “substantially absent” in combination with the amount of agglomerated of carbide (S) of size exceeding 100 nm is to be understood to mean that a SEM magnification of a fractured surface of the composition (C), when analyzed electronically by computerized image analysis, will account for a fraction of surface occupied by agglomerates having maximal dimension exceeding 100 nm of less than 3%, preferably less than 2%, even more preferably of less than 1%, with respect to the total area of the sample.

The expression ‘maximal dimension’ as associated to agglomerates is the maximum size derived from the distance of two tangents to the contour of the agglomerate, when assessing whichever orientation. In simpler words, this method corresponds to the measurement by a slide gauge of agglomerates.

The composition (C) can be notably cured by peroxide curing technique, by ionic curing technique, by nitrile-curing techniques when fluoroelastomer comprises nitrile cure sites, including catalytic curing with e.g. Sn compounds, or amino-based curing, or by any “mixed” technique.

The composition (C) of the invention can be advantageously cured by peroxide curing technique.

To this aim, the composition (C) generally further comprises at least one suitable peroxide that is capable of generating radicals by thermal decomposition. Organic peroxides are generally employed.

Among most commonly used peroxides, mention can be made of dialkyl peroxides, for instance di-tert-butyl peroxide and 2,5-dimethyl-2,5-bis(tert-butylperoxy)hexane; dicumyl peroxide; dibenzoyl peroxide; di-tert-butyl perbenzoate; bis[1,3-dimethyl-3-(tert-butylperoxy)butyl] carbonate. Other suitable peroxide systems are those described, notably, in patent applications EP 136596 A (MONTEDISON SPA) 10 Apr. 1985 and EP 410351 A (AUSIMONT SRL) 30 Jan. 1991, whose content is hereby incorporated by reference.

The composition (C) generally comprises at least one polyunsaturated compound, which is generally believed to act as a curing agent. In this case, the composition (C) comprises said polyunsaturated compound in amounts generally of from 0.5 to 10 phr, and preferably of from 1 to 7 phr, relative to 100 weight parts of fluoroelastomer (A).

Among polyunsaturated compound which may be used, the following can be listed: triallyl cyanurate; triallyl isocyanurate (TAIC); tris(diallylamine)-s-triazine; triallyl phosphite; N,N-diallylacrylamide; N,N,N′,N′-tetraallylmalonamide; trivinyl isocyanurate; 2,4,6-trivinyl methyltrisiloxane; bis-olefins (OF), as above detailed; triazines substituted with ethylenically unsaturated groups, such as notably those described in EP 860436 A (AUSIMONT SPA) 26 Aug. 1998 and WO 97/05122 (DU PONT [US]) 13 Feb. 1997; among above mentioned curing coagents, TAIC and bis-olefins (OF), as above detailed, and more specifically TAIC and bis-olefins of formula (OF-1), as above detailed, have been found to provide particularly good results.

The composition (C) may further additionally comprise ingredients which maybe commonly used for the peroxide curing of fluoroelastomers; more specifically, composition (C) may generally further comprise

(a) one or more than one metallic basic compound, in amounts generally of from 0.5 to 15 phr, and preferably of from 1 to 10 phr, relative to 100 weight parts of fluoroelastomer (A); metallic basic compounds are generally selected from the group consisting of (j) oxides or hydroxides of divalent metals, for instance oxides or hydroxides of Mg, Zn, Ca or Pb, and (jj) metal salts of a weak acid, for instance Ba, Na, K, Pb, Ca stearates, benzoates, carbonates, oxalates or phosphites;
(b) one or more than one acid acceptor which is not a metallic basic compound, in amounts generally of from 0.5 to 15 phr, and preferably of from 1 to 10 phr, relative to 100 weight parts of fluoroelastomer (A); these acid acceptors are generally selected from nitrogen-containing organic compounds, such as 1,8-bis(dimethylamino)naphthalene, octadecylamine, etc., as notably described in EP 708797 A (DU PONT) 1 May 1996;
(c) other conventional additives, such as fillers, thickeners, pigmen-ts, antioxidants, stabilizers, processing aids, and the like.

The invention also pertains to a method for fabricating shaped articles comprising curing the composition (C), as above described.

The composition (C) can be fabricated, e.g. by moulding (injection moulding, extrusion moulding), calendering, or extrusion, into the desired shaped article, which is advantageously subjected to vulcanization (curing) during the processing itself and/or in a subsequent step (post-treatment or post-cure), advantageously transforming the relatively soft, weak, fluoroelastomeric uncured composition into a finished article made of non-tacky, strong, insoluble, chemically and thermally resistant cured fluoroelastomer material.

Yet, the invention pertains to cured articles obtained from the composition (C), as above detailed. Said cured articles are generally obtained by moulding and curing the fluoroelastomer composition, as above detailed. These cured articles may be sealing articles, including O(square)-rings, packings, gaskets, diaphragms, shaft seals, valve stem seals, piston rings, crankshaft seals, cam shaft seals, and oil seals or maybe piping and tubings, in particular flexible hoses or other items, including conduits for delivery of hydrocarbon fluids and fuels.

Cured articles obtained from the composition (C), thanks to their outstanding mechanical properties, their plasma resistance, and absence of metal fillers, are suitable for being used in fields of endeavours wherein extremely demanding conditions of use are combined with high purity requirements, e.g. for use in semi-conductor manufacturing devices, e.g. as seals, door sleeves, components and sealing elements of vacuum pumps, pendulum valves components, gate valves components, gas inlet/outlet components.

Further in addition, the invention pertains to a method for processing the composition (C), as above detailed, according any of injection moulding, compression moulding, extrusion moulding, coating, screen printing technique, form-in-place technique.

Should the disclosure of any of the patents, patent applications, and publications that are incorporated herein by reference conflict with the present description to the extent that it might render a term unclear, the present description shall take precedence.

The present invention will be now described in more detail with reference to the following examples, whose purpose is merely illustrative and not limitative of the scope of the invention.

### EXAMPLES

SiC NM 99 is a silicon carbide nanopowder grade of 5N purity (99.999%), commercially available from Nanomackers, having an average particle size of about 35 nm (SiC, herein after).

TECNOFLON® 95HT perfluororubber (PFR) [PFR 95HT, herein after]latex is a TFE/MVE perfluoroelastomer matex having a PFR content of 30.2% wt, commercially available from Solvay Specialty Polymers Italy S.p.A.

### Example 1

### Ex. 1 (a) Preparation of the SiC Dispersion

To 10 g water were added 18.2 g of SiC, and subsequently 437 g ethylene glycol, under 35 rpm mechanical stirring; an additional amount of water (100 g) was further added, and mechanical stirring rate was raised up to 530 rpm until homogenous slurry was obtained.

### Ex. 1 (b) Co-Coagulation Procedure

In a 2 liter flask 507 g of PFR 95HT latex (dry content: 30.2% by weight) was mixed with 483 g of the SiC dispersion (dry content: about 3.5% by weight) as prepared in step (a), under magnetic stirring at room temperature. The so-obtained mixture was coagulated in 1500 cc of a nitric acid solution at pH=0.5. The co-coagulated product was dried at 120° C. in a air-circulating oven for 16 hours. 170 g of final polymer, constituted by 90% PFR 95HT/10% filler SiC (w/w) was obtained and formulated into a curable composition using the ingredients listed in Table 1.

Dry content of PFR 95HT latex and slurry SiC have been determined at 160° C. by using of equipment Mettler Toledo HB43-S Compact Halogen Moisture Analyzer and calculated as a percentage of the dry weight of sample (DW) to initial wet weight of sample (WW):

$$Dry content = \frac{DW}{WW} \cdot 100 \% .$$

### Comparative Example 2

A comparative composition was manufactured by mechanically mixing crumbs of PFR 95HT with powdery SiC in an open mill together with all other compounding ingredients, as detailed in Table 1, so as to produce mechanically mixed composition constituted by 90% PFR 95HT/10% filler SiC (w/w).

Characterization of the Fluoroelastomer Compositions

The following characterizations were carried out:

TGA

TGA was performed according to ASTM D6370, heating in a 1^{st} cycle under nitrogen (N₂) from 30° C. up to a temperature of 750° C. (1^{st}/in N₂) and determining weight low (% wt) and residue (% wt); and, next, after cooling to 300° C., heating in a 2^{nd} cycle from 300° C. to 750° C. in air (2nd/in Air) and determining additional weight low (% wt) and final residue (% wt); results are summarized in the table. Comparisons of data on compound obtained by dry mixing corroborate the finding that co-coagulation technique is effective in achieving quantitative incorporation of carbide of the dispersion in the coagulated fluoroelastomer crumb. Values of residue diverging from expected theoretical 10% wt are equally found in results for compound obtained by mechanical mixing, and are explained taking into account possible SiC carbide decomposition to volatile SiF₄ in the presence of HF.

SEM

The analyses have been carried out using a Field Emission SEM Leo Supra 35. Samples of formulated/uncured compounds have been obtained through cryogenic microfracture with hammer breakage. Samples have been observed after metalization with a 20 nm Cr layer. The analysis has been carried out through the capture of 7 different pictures at a magnification of 50×. Every picture covered an area of 26.88 μm². Through software-assisted image analysis, aggregates having maximal dimension exceeding 100 nm were identified, and their area measured as a fraction (%) with respect to the overall area of the specimen.

Mechanical Property Determination on Cured Samples

Composition of Ex. 1 and PFR 95HT were compounded with the additives as detailed in Table 1. Plaques have been cured in a pressed mould and then post-treated in an air circulating oven in conditions (time, temperature) below specified.

The tensile properties have been determined on specimens punched out from the plaques, according to the DIN 53504 S2 Standard.

The Shore A hardness (3″) (HDS) has been determined on 3 pieces of plaque piled according to the ASTM D 2240 method.

The compression set (C-SET) has been determined on O-ring, spaceman standard AS568A (type 214) or on 6 mm buttons (type 2), according to the ASTM D 395, method B.

Cure behaviour was characterized by Moving Die Rheometer (MDR), in conditions as specified below, by determining the following properties:

M_{L}=Minimum torque (lb×in)
M_{H}=Maximum torque (lb×in)
t_{S2}=Scorch time, time for two units rise from M_{L} (sec);
t′_{XX}=Time to XX % state of cure (sec).

TABLE 1

| | Ex. 2C | Ex. 1 |
|---|---|---|
| PFR 95HT | 100.0 | |
| From Ex. 1 | | 100.0 |
| Bis-olefin(1) | 1.5 | 1.5 |
| Peroxide(2) | 1.0 | 1.0 |
| SiC | 10.0 | |

MDR-12 min @ 170° C.

| | | | |
|---|---|---|---|
| M_{L} | lb × in | 1.6 | 1.7 |
| M_{H} | lb × in | 12.9 | 8.1 |
| tₛ₂ | s | 44 | 85 |
| t′₀₂ | s | 33 | 40 |
| t′₅₀ | s | 94 | 113 |
| t′₉₀ | s | 404 | 371 |

| | |
|---|---|
| Molding Condition | 10 min @ 170° C. |
| Postcure Condition | (1 + 4) h @ 230° C. |

| | | |
|---|---|---|
| Atmosphere | Air | Air |

Mechanical Properties (23° C. @ DIN 53504 S2)

| | | | |
|---|---|---|---|
| Tensile Strength | MPa | 18.2 | 18.5 |
| 50% Modulus | MPa | 1.5 | 1.6 |
| 100% Modulus | MPa | 2.9 | 2.8 |
| Elongation @ Break | % | 215 | 305 |
| Hardness | Shore A | 67 | 69 |

TGA analysis

| | | | |
|---|---|---|---|
| weight loss [%] | 1^{st}/in N₂ | 91.8 | 91.6 |
| | 2^{nd}/in Air | 0.9 | 0.8 |
| residual [%] | 1^{st}/in N₂ | 8.2 | 8.4 |
| | 2^{nd}/in Air | 7.3 | 7.6 |

SEM image analysis

| | | | |
|---|---|---|---|
| Area of aggregates | % | 3.7 | 0 |
| having maximal | | | |
| dimension exceeding | | | |
| 100 nm | | | |

(1)Crosslinking agent: bis-olefin compound of formula/CH₂═CH—(CF₂)₆—CH═CH₂ commercially available from Solvay Specialty Polymers
(2)Catalyst agent: LUPEROX ® 101 liquid from Atofina, neat 2,5-dimethyl-2,5-di(t-butylperoxy)hexane (C₁₆H₃₄O₄).

1. A method for manufacturing a fluoroelastomer composition (C), said method comprising:
mixing a dispersion (S) and a latex (L), wherein
dispersion (S) is an aqueous dispersion of particles of at least one carbide (S),
carbide (S) is a non-metal carbide possessing an average particle size of less than 100 nm,
latex (L) is an aqueous latex of at least one fluoroelastomer (A), and
fluoroelastomer (A) is a (per)fluoroelastomer,
in such amounts so as to obtain an aqueous mixture (M) comprising from 1 to 50 weight parts of carbide (S), per 100 parts of fluoroelastomer (A); and
coagulating the mixture (M), so as to recover the composition (C).

2. The method of claim 1, which comprises providing dispersion (S) in a liquid dispersing medium comprising water and at least one hydroxyl-containing organic solvent, wherein dispersion (S) comprises at least 30% wt of hydroxyl-containing organic solvent, with respect to the total weight of dispersion (S), and/or dispersion (S) comprises at most 85% wt of hydroxyl-containing organic solvent, with respect to the total weight of dispersion (S).

3. The method of claim 1, wherein dispersion (S) comprises particles of at least one carbide (S) selected from the group consisting of silicon carbide (SiC) and boron carbide (BC), and/or wherein the particles of carbide (S) possess an average particle size of less than 100 nm and/or an average particle size of at least 1 nm.

4. The method of claim 1, wherein dispersion (S) comprises at least 0.5% wt of carbide (S), with respect to the total weight of the dispersion (S) and/or dispersion (S) comprises at most 10% wt of carbide (S), with respect to the total weight of dispersion (S).

5. The method of claim 1, said method comprising providing latex (L) comprising the fluoropolymer (A) in an amount of at least 15% wt., and/or in an amount of at most 60% wt., with respect to the total weight of latex (L).

6. The method of claim 1, wherein fluoroelastomer (A) is selected from the group consisting of:
(1) vinylidene fluoride (VDF)-based copolymers, in which VDF is copolymerized with at least one comonomer selected from the group consisting of:
(a) C₂-C₈ perfluoroolefins;
(b) hydrogen-containing C₂-C₈ olefins;
(c) C₂-C₈ fluoroolefins comprising at least one of iodine, chlorine and bromine;
(d) (per)fluoroalkylvinylethers (PAVE) of formula CF₂═CFOR_{f}, wherein R_{f} is a C₁-C₆ (per)fluoroalkyl group;
(e) (per)fluoro-oxy-alkylvinylethers of formula CF₂═CFOX, wherein X is a C₁-C₁₂ ((per)fluoro)-oxyalkyl comprising catenary oxygen atoms;
(f) (per)fluorodioxoles having formula: 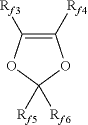
wherein each of R_{f3}, R_{f4}, R_{f5}, R_{f6}, equal to or different from each other, is independently selected from the group consisting of fluorine atom and C₁-C₆ (per)fluoroalkyl groups, optionally comprising one or more than one oxygen atom;
(g) (per)fluoro-methoxy-vinylethers (MOVE) having formula:
CF₂═CFOCF₂OR_{f2}
wherein R_{f2} is selected from the group consisting of C₁-C₆ (per)fluoroalkyls; C₅-C₆ cyclic (per)fluoroalkyls; and C₂-C₆ (per)fluorooxyalkyls, comprising at least one catenary oxygen atom;
(h) C₂-C₈ non-fluorinated olefins (Ol);
(i) ethylenically unsaturated compounds comprising nitrile (—CN) groups, optionally (per)fluorinated; and
(2) TFE-based copolymers, in which TFE is copolymerized with at least one comonomer selected from the group consisting of (c), (d), (e), (g), (h) and (i) as above detailed.

7. The method of claim 1, which comprises mixing dispersion (S) and latex (L) in such amounts as to obtain a mixture (M) comprising at least 1 phr of carbide (S) with respect to fluoroelastomer (A) and/or comprising at most 40 phr of carbide (S) with respect to fluoroelastomer (A).

8. The method of claim 1, wherein mixing dispersion (S) and latex (L) is carried out in standard devices selected from the group consisting of agitated vessels, having vertical and/or radial flow impellers and/or possibly equipped with baffles.

9. The method of claim 1, wherein mixture (M) is coagulated through addition of an electrolyte selected from the group consisting of sulphuric acid, nitric acid, hydrochloridric acid, magnesium nitrate, aluminum sulphate or through an electrolyte-free technique selected from the group consisting of coagulation through high pressure compression/decompression; coagulation under high shear; and coagulation by freeze/taw techniques.

10. The method of claim 1, wherein coagulate generated during the coagulation is separated from the dispersing medium using conventional techniques selected from the group consisting of flotation, filtration, centrifugation, decantation, and a combination of these techniques.

11. A fluoroelastomer composition (C), comprising at least one fluoroelastomer (A) and at least one carbide (S) in an amount of 1 to 50 weight parts per hundred parts of fluoroelastomer (A), wherein carbide (S) is dispersed in the fluoroelastomer (A) in a manner such that agglomerates of particles of carbide (S) having a size exceeding 100 nm are substantially absent.

12. The composition (C) of claim 11, wherein fluoroelastomer (A) is selected from the group consisting of fluoroelastomers having the following monomer compositions (in mol %, with respect to the total moles of recurring units):
(i) vinylidene fluoride (VDF) 35-85%, hexafluoropropene (HFP) 10-45%, tetrafluoroethylene (TFE) 0-30%, (per)fluoroalkylvinylethers (PAVE) 0-15%; bis-olefin (OF): 0-5%;
(ii) vinylidene fluoride (VDF) 50-80%, (per)fluoroalkylvinylethers (PAVE) 5-50%, tetrafluoroethylene (TFE) 0-20%, bis-olefin (OF): 0-5%;
(iii) vinylidene fluoride (VDF) 20-30%, C₂-C₈ non-fluorinated olefins (Ol) 10-30%, hexafluoropropene (HFP) and/or (per)fluoroalkylvinylethers (PAVE) 18-27%, tetrafluoroethylene (TFE) 10-30%; bis-olefin (OF): 0-5%;
(iv) tetrafluoroethylene (TFE) 50-80%, (per)fluoroalkylvinylethers (PAVE) 15-50%; bis-olefin (OF): 0-5%;
(v) tetrafluoroethylene (TFE) 45-65%, C₂-C₈ non-fluorinated olefins (Ol) 20-55%, vinylidene fluoride 0-30%; bis-olefin (OF): 0-5%;
(vi) tetrafluoroethylene (TFE) 32-60% mol %, C₂-C₈ non-fluorinated olefins (Ol) 10-40%, (per)fluoroalkylvinylethers (PAVE) 20-40%, fluorovinyl ethers (MOVE) 0-30%; bis-olefin (OF): 0-5%;
(vii) tetrafluoroethylene (TFE) 33-75%, (per)fluoroalkylvinylethers (PAVE) 15-45%, vinylidene fluoride (VDF) 5-30%, hexafluoropropene HFP 0-30%; bis-olefin (OF): 0-5%;
(viii) vinylidene fluoride (VDF) 35-85%, (per)fluoro-methoxy-vinylethers (MOVE) 5-40%, (per)fluoroalkylvinylethers (PAVE) 0-30%, tetrafluoroethylene (TFE) 0-40%, hexafluoropropene (HFP) 0-30%; bis-olefin (OF): 0-5%; and
(ix) tetrafluoroethylene (TFE) 20-70%, (per)fluoro-methoxy-vinylethers (MOVE) 25-75%, (per)fluoroalkylvinylethers (PAVE) 0-50%, bis-olefin (OF): 0-5%.

13. The composition (C) of claim 11, further comprising at least one suitable peroxide that is capable of generating radicals by thermal decomposition.

14. A method of fabricating shaped articles comprising curing the composition (C) of claim 11.

15. A cured article obtained from the composition (C) of claim 1, wherein the article is selected from the group consisting of sealing articles, O(square)-rings, packings, gaskets, diaphragms, shaft seals, valve stem seals, piston rings, crankshaft seals, cam shaft seals, oil seals, piping, tubing, flexible hoses and conduits for delivery of hydrocarbon fluids and fuels.

16. The method of claim 2, wherein dispersion (S) comprises at least 50 wt and at most 80% wt of hydroxyl-containing organic solvent, with respect to the total weight of dispersion (S).

17. The method of claim 3, wherein dispersion (S) comprises particles of silicon carbide (SiC).

18. The method of claim 3, wherein the particles of carbide (S) possess an average particle size of at least 10 nm and less than 60 nm.

19. The method of claim 4, wherein dispersion (S) comprises at least 2% wt and at most 8% wt of carbide (S), with respect to the total weight of dispersion (S).

20. The method of claim 5, said method comprising providing latex (L) comprising the fluoropolymer (A) in an amount of at least 25% wt. and at most 40% wt., with respect to the total weight of latex (L).
